(19) United States
(12) Patent Application Publication
(10) Pub. No.: US 2004/0237753 A1
(43) Pub. Date: Dec. 2, 2004

(54) Magnetic guitar pick or plectrum used to play stringed musical instruments

(76) Inventor: Brett Wayne Savage, Dana Point, CA (US)

Correspondence Address: BRETT SAVAGE, 33141 OCEAN BRIGHT, DANA POINT, CA, 92629, US

(21) Appl. No.: 10/691,864

(22) Filed: Oct. 24, 2003

Related U.S. Application Data
(60) Provisional application No. 60/473,289, filed on May 27, 2003.

(51) Int. Cl. G10D 3/16

(52) U.S. Cl. 84/322

(57) ABSTRACT

Magnetic guitar pick or plectrum used to play stringed musical instruments. The magnet is imbedded in the pick by means of a milling or molding process which allows the pick or plectrum to be magnetically attached to any metal surface such as a microphone stand, guitar stand or any other metal object.

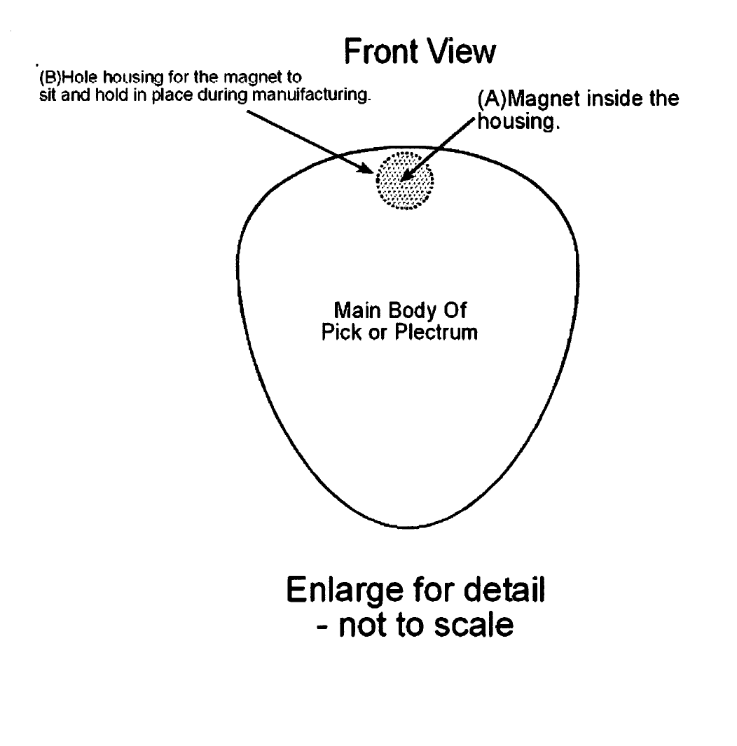

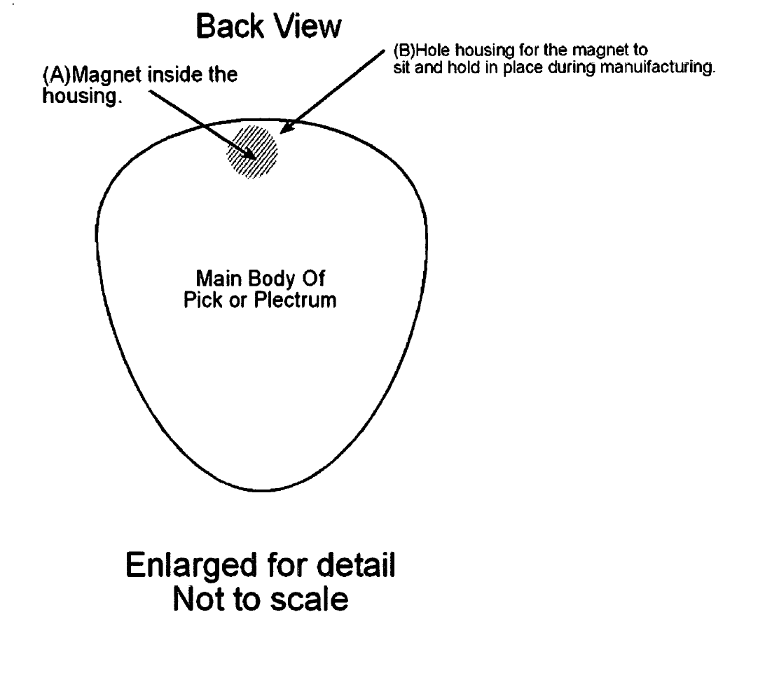

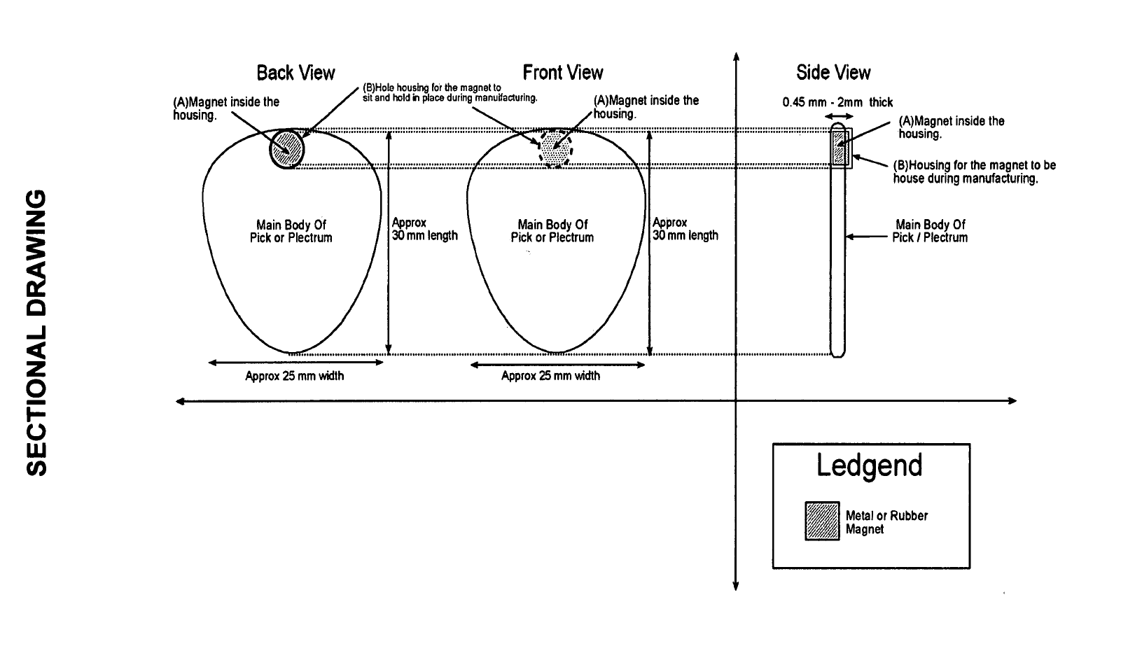

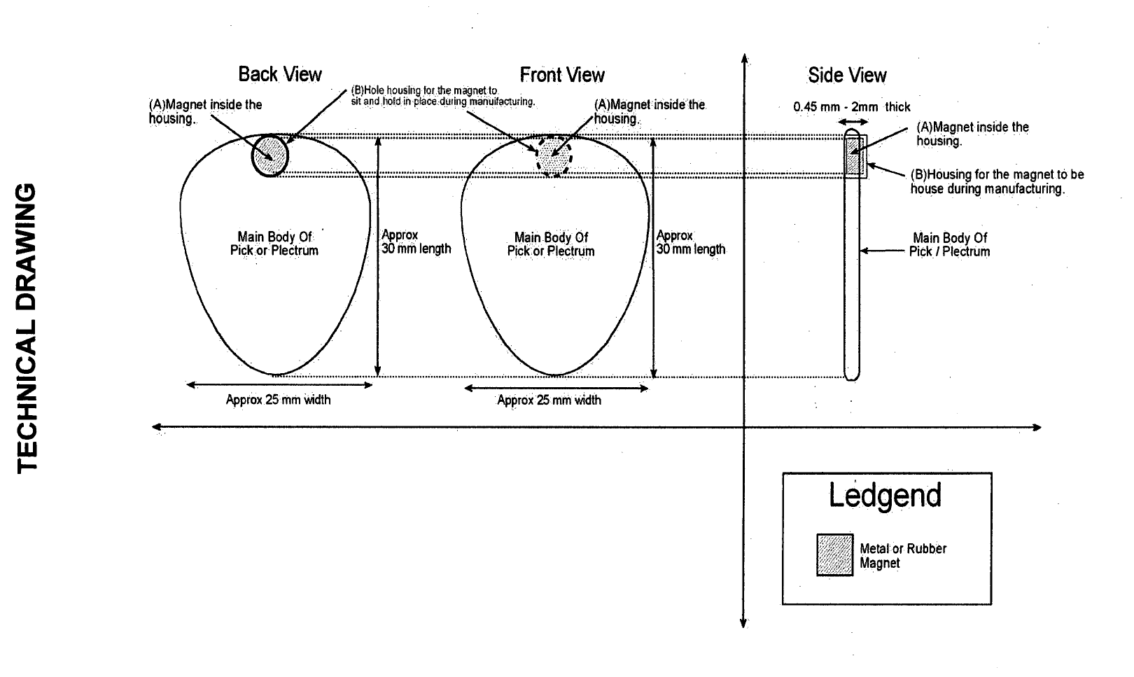

### FIELD OF ENDEAVOR

The invention relates to the field of devises used to play or aid in playing electric and accoustic stringed musical instruments.

### BACKGROUND OF THE INVENTION

A stringed musical instrument is normally played by means of striking or picking the strings with the movement of the hands and fingers over the strings. This movement of the hand and fingers is commonly know as “Strumming”. A devise called a pick or plectrum is used to or aid in the process of strumming. The pick or plectrum is place between the thumb and index finger and is used to strike the strings during the strumming process. Picks or plectrums are made in different sizes and shapes composed of many different materials. The most commonly used method of construction is by means of milling or molding a composite of either plastic or nylon into a rounded triangular shaped. Most every person who plays musical instrument with the aid of a pick or plectrum will encounter the age old problem of dropping the pick or plectrum whilst playing the musical instrument. Due to this problem people usually have spare additional picks or plectrums near by to use if this happens. This new invention has a small magnet embedded in the pick or plectrum which allows a person to attach the pick or plectrum to any metal surface which would include a microphone stand, guitar stand or metal object on the guitar which are commonly made of steel or metal. In the past people would use double sided sticky tape to adhere the picks to the microphone stand or the guitar stand. This new invention allows a person to apply the pick or plectrum to any metal surface with out the use of any additional attachment devise or method of adhesion. This allows a person to quickly obtain a spare pick or plectrum at any time if needed hence making it easier to continue playing without interruption from dropping picks or plectrums.

### BRIEF SUMMARY OF THE INVENTION

The invention is a magnet pick or plectrum of any shape or size which is either milled or molded of plastic, nylon or any composite thereof. A magnet is imbedded in the pick or plectrum and allows the pick or plectrum to be magnetically attached to any metal object including a microphone stand and guitar stand. A housing is designed into the pick or plectrum and is used to house the magnet. The function of my invention is to allow a guitarist to play the guitar normally with the ability to have multiple guitar picks or plectrums attached to a microphone stand or any metal object in front of him/her or near by. If and when he drops the pick or plectrum whilst or during playing the guitar, he will be able to quickly access a spare one which would be magnetically attached to the microphone stand or any metal object close by.

### DESCRIPTION OF DRAWING VIEWS

The technical drawing herein is one drawing made up of a front, back and side view of the pick or plectrum. The use of one drawing with the different views allows a person to better understand how the pick is constructed. The views shows the general perimeter of the main body of the pick and how it relates to the housing (B) and the magnet (A) placement. The front, Back and side view shows the main body, housing (B) and actual magnet (A). It shows the placement of the house (B) and the magnet (A) in all three views to better show the position of the housing (B) and the magnet (A) relative to the main body. The sketches are not to scale and measurements illustrated in the drawing are used to show the general size of the pick in relation to the housing (B) and the magnet (A). The size of the magnet and the pick varies as indicated in the specifications of the invention.

(A)=Illustrate the magnet

(B)=Illustrates the housing in which the magnet is housed

### DETAILED DESCRIPTION OF THE INVENTION

The invention is a magnet pick or plectrum of any shape or size which is either milled or molded of plastic, nylon or any composite thereof. A magnet is imbedded in the pick or plectrum and allows the pick or plectrum to be magnetically attached to any metal object including a microphone stand and guitar stand. A housing is designed into the pick or plectrum and is used to house the magnet. The function of my invention is to allow a guitarist to play the guitar normally with the ability to have multiple guitar picks or plectrums attached to a microphone stand or any metal object in front of him/her or near by. If and when he drops the pick or plectrum whilst or during playing the guitar, he will be able to quickly access a spare one which would be magnetically attached to the microphone stand or any metal object close by. The main body is constructed by means of Milling or molding process. The Milling process is done by a means of cutting out or punching out techniques cutting the form and shape of the pick from a sheet of plastic, nylon or a composite thereof. Once the main body of the pick or plectrum is formed a housing is then drilled into the top area of the pick as illustrated in the technical draw (B). This drill hole is called the magnet housing. The housing (B) is where the magnet is place with the use of an adhesive to hold the magnet (A) in the housing (B) thus completing the magnet pick or plectrum. The injection molding process is done by means of creating a mold in the form of the pick or plectrum which creates the main body of the pick or plectrum. The housing (B) is created in the same mold and is created as an indentation in the mold in where the magnet (A) will be housed during the injection process. Once the mold has been created the magnet (A) is placed in the housing (B). The mold is then injected (via standard injection mold procedure) with hot liquid nylon, or plastic (or composite of both). This procedure forces the liquid nylon, or plastic (or composite of both) which takes the form of the main body of the mold and incases the magnet (A) into the main body of the pick or plectrum. When the mold is cooled and opened the pick or plectrum is in the perfect shape of the mold (main body) and has the magnet sealed inside.

1. What I claim as my invention is a magnetic pick or plectrum of any shape and size which is use to assist in playing stringed electric or acoustic musical instruments. The magnet is imbedded in the pick or plectrum and allows the pick or plectrum to be magnetically attached to any metal surface such as a microphone stand or guitar stand. The means of imbedding the magnet in the pick is by machine milling. The Milling process is done by a means of cutting out or punching out techniques cutting the form and shape of the pick from a sheet of plastic, nylon, metal or a composite thereof. Once the main body of the pick or plectrum is cut out, a housing (as shown as (B) in the technical drawing) is then drilled into the top area of the pick as illustrated in the technical draw. This drill hole is called the magnet housing (B). The housing (B) is where the magnet (as shown as (A) in the technical drawing) is place with the use of an adhesive to hold the magnet (A) in the housing (B) thus completing the magnet pick or plectrum.

2. What I claim as my invention is a magnetic pick or plectrum of any shape and size which is use to assist in playing stringed electric or acoustic musical instruments. The magnet is imbedded in the pick or plectrum and allows the pick or plectrum to be magnetically attached to any metal surface such as a microphone stand or guitar stand. The means of imbedding the magnet in the pick is by injection molding. The injection molding process is done by means of creating a mold in the form of the pick or plectrum which creates the main body of the pick or plectrum. The housing (shown as (B) in the technical drawing) is created in the same mold and is created as an indentation in the mold in where the magnet (as shown as (A) in the technical drawing) will be housed during the injection process. Once the mold has been created the magnet (A) is placed in the housing (B). The mold is then injected (via standard injection mold procedure) with hot liquid nylon (or composite of nylon). This procedure forces the liquid nylon, or plastic (or composite of both) which takes the form of the main body of the mold and in cases the magnet (A) into the main body of the pick or plectrum. When the mold is cooled and opened the pick or plectrum is in the perfect shape of the mold (main body) and has the magnet sealed inside.

3. What I claim as my invention is a magnetic pick or plectrum of any shape and size which is use to assist in playing stringed electric or acoustic musical instruments as indicated in claim No 2. The magnet is imbedded in the pick or plectrum and allows the pick or plectrum to be magnetically attached to any metal surface such as a microphone stand or guitar stand. The means of imbedding the magnet in the pick is by injection molding. The injection molding process is done by means of creating a mold in the form of the pick or plectrum which creates the main body of the pick or plectrum. The housing (shown as (B) in the technical drawing) is created in the same mold and is created as an indentation in the mold in where the magnet (as shown as (A) in the technical drawing) will be housed during the injection process. Once the mold has been created the magnet (A) is placed in the housing (B). The mold is then injected (via standard injection mold procedure) with hot liquid nylon, or plastic (or composite of both). This procedure forces the liquid plastic (or composite of plastic) which takes the form of the main body of the mold and in cases the magnet (A) into the main body of the pick or plectrum. When the mold is cooled and opened the pick or plectrum is in the perfect shape of the mold (main body) and has the magnet sealed inside.

4. What I claim as my invention is a magnetic pick or plectrum of any shape and size which is use to assist in playing stringed electric or acoustic musical instruments as indicated in claim No 2. The magnet is imbedded in the pick or plectrum and allows the pick or plectrum to be magnetically attached to any metal surface such as a microphone stand or guitar stand. The means of imbedding the magnet in the pick is by injection molding. The injection molding process is done by means of creating a mold in the form of the pick or plectrum which creates the main body of the pick or plectrum. The housing (shown as (B) in the technical drawing) is created in the same mold and is created as an indentation in the mold in where the magnet (as shown as (A) in the technical drawing) will be housed during the injection process. Once the mold has been created the magnet (A) is placed in the housing (B). The mold is then injected (via standard injection mold procedure) with hot liquid nylon, or plastic (or composite of both). This procedure forces the liquid rubber (or composite of rubber) which takes the form of the main body of the mold and in cases the magnet (A) into the main body of the pick or plectrum. When the mold is cooled and opened the pick or plectrum is in the perfect shape of the mold (main body) and has the magnet sealed inside.

5. What I claim as my invention is a magnetic pick or plectrum of any shape and size which is use to assist in playing stringed electric or acoustic musical instrument as indicated in claim No 2. The magnet is imbedded in the pick or plectrum and allows the pick or plectrum to be magnetically attached to any metal surface such as a microphone stand or guitar stand. The means of imbedding the magnet in the pick is by cast molding. The injection molding process is done by means of creating a mold in the form of the pick or plectrum which creates the main body of the pick or plectrum. The housing (shown as (B) in the technical drawing) is created in the same mold and is created as an indentation in the mold in where the magnet (as shown as (A) in the technical drawing) will be housed during the injection process. Once the mold has been created the magnet (A) is placed in the housing (B). The mold is then injected (via standard injection mold procedure) with hot liquid nylon, or plastic (or composite of both). This procedure pours liquid steel or metal (or composite of both) which takes the form of the main body of the mold and in cases the magnet (A) into the main body of the pick or plectrum. When the mold is cooled and opened the pick or plectrum is in the perfect shape of the mold (main body) and has the magnet sealed inside.
